(19) United States
(12) Patent Application Publication
(10) Pub. No.: US 2004/0181519 A1
(43) Pub. Date: Sep. 16, 2004

(54) Method for generating multidimensional summary reports from multidimensional summary reports from multidimensional data

(76) Inventor: Mohammed Shahbaz Anwar, Houston, TX (US)

Correspondence Address: ROBERT W STROZIER, P.L.L.C, PO BOX 429, BELLAIRE, TX, 77402-0429, US

(21) Appl. No.: 10/483,304

(22) PCT Filed: Jul. 9, 2002
(86) PCT No.: PCT/US02/21538

(51) Int. Cl. G06F 17/30

(52) U.S. Cl. 707/3

(57) ABSTRACT

A method for locating data anomalies (exceptions) in a multi-dimensional data cube is disclosed, where the method uses certain properties called anti-monotone constraints of aggregated data in the cube to reduce the search space during data analysis and anomaly detection.

### BACKGROUND OF THE INVENTION

1. Field of the Invention

The present invention relates to a method implemented on a computer or in a computer for reducing a search space associated with a user constructed search using anti-monotonic constraints permitting efficient search space pruning and to computers and computer readable media having the method encoded therein or thereon. The present invention also relates to a method for graphically displaying data using Pareto charts and modified Pareto Charts.

More particularly, the present invention relates to a method implemented on a computer or in a computer, where the method involves interaction with a user to select a search space, construct a search, and construct at least one constraint for the search. The method then generates all one dimensional item sets and discards all one dimensional item sets not satisfying the constraint. The method then used this reduced set of one dimensional item sets to construct two dimensional item sets and discards all two item sets that do not satisfy the constraint. This process is continued until no k-dimensional item sets satisfy the constraint. This invention also relates to computer and computer readable media having the method encoded therein or thereon.

2. Description of the Related Art

On-Line Analytical Processing (OLAP) is a technique for summarizing, viewing, analyzing, and synthesizing multi-dimensional data. OLAP technology enables users to gain insight into the data they want to analyze through rapid access to a wide variety of data views that are organized to reflect the multidimensional nature of the data. To create an OLAP cube from a collection of data, a number of attributes associated with the data are selected. Some of the attributes are chosen to be metrics of interest referred to “measures,” while the remaining attributes are referred to as “dimensions.” Dimensions usually have associated “hierarchies” that are arranged in aggregation levels providing different levels of granularity for viewing the data.

One of the simplest and common analysis carried out in OLAP environment is known as Exceptions analysis. This kind of analysis aims at finding interesting multidimensional cell values in a data cube. Formally, an exception is nothing more than an interesting value that is significantly different from the rest, across all dimensions to which the cell belongs. This analysis is commonly done by first defining a set of dimensions to look for anomalies, usually the exploration starts at the highest level of hierarchy of each selected cube dimension and continues by using a sequence of “drill-down” operations (zooming into more detailed levels of hierarchies). For each combination of dimensions, the exceptions search is carried out to find anomalies in the data.

This approach has several drawbacks. The search space can be extremely large, because a cube could have hundred plus dimensions, each dimension could have a hierarchy that is hundred plus levels deep, and each level of the hierarchy could have ten, hundred, even thousands of members. These numbers are only representative estimation and they tend to increase, as more powerful hardware becomes available.

Through brute force, looking at data aggregated at various levels of details to find out an exception is impractical. The interesting anomaly can be one of the several million, billion or even trillion values hidden in the detailed data. Even if one is viewing data at the same level of detail as where the exception occurs, it might be hard to notice the anomaly because of the large number of values at the very same level.

Vilfredo Pareto (1848-1923), an Italian economist and sociologist, in 1906 observed that eighty percent of the wealth in Italy was owned by twenty percent of the people. Dr. Joseph Juran (of total quality management fame) expanded the work of Vilfredo Pareto and stated the principle that a small number of causes (20%) are responsible for a large percentage (80%) of the effects. Recognizing the relationships the Pareto charts reveal will allow the user the opportunity to let participants have a say in the decision process. By attacking the causes that really matter, the user will be more successful in identifying solutions that might be more acceptable and useful.

Thus, there is a need in the art for a new exception finder algorithm that automatically searches for an exceptional data that satisfy certain properties. This guided method will increase the chances of user detecting abnormal patterns in the data.

### SUMMARY OF THE INVENTION

The present invention provides a method for finding constraint satisfying data including the steps of selecting search space, where the selection process involves selecting an n-dimensional OLAP data cube, which may be spun for this search from data in one or more databases, selecting a set of dimensions from the cube schema and selecting a measure from the cube schema. After the search space has been selected, the user constructs a search including at least one a primary anti-monotonic constraint or condition (e.g., Boolean operations) and optionally one or more must-include constraints, one or more secondary constraints or rules on the measure (e.g., item set size, Boolean operations, or the like) and/or one or more data filters. If a data filter is specified, then the search space is first narrowed to data satisfying the all of the data filters. After the search space has been selected and the search constructed, the method sets an iteration counter k, equal to, 1 and generates all one dimensional (1D) item sets, where a 1D item set is set comprising a member of a selected dimension with its associated measure value. Now the method removes all 1D item sets that have a measure value that does not satisfy the search. If secondary constraints have. been specified, then the method also removes all item sets that fail the secondary constraint, further reducing the search space in the next iteration. This removal step greatly reduces that search space in the next iteration. The iteration counter is then incremented or bumped and the generation and removal steps are repeated. Again, the removal step reduces that search space in the next iteration. Because higher dimensional item sets represent a smaller and smaller collection of data, eventually no kD item set will satisfy the search and the method stops. After stopping, the method displays the results of the search as a list of item sets that satisfied the search. The method is ideally suited for generating top ten or top n item sets that satisfy a given search.

The present invention also provides a method for post analysis of the item set found in using the method described above, where the post-analysis includes the steps of dragging a qualified item set into a cross-tab window, where the item set is converted to a cross-tab. The data in the cross-tab can then be subjected to statistical analyses, slice and dice refinements, non-included dimension or dimension member refinements or any other post processing operation. The cross-tab is constructed as follows. If all dimensions include a member list greater than a default value or user set value, then the cross-tab will display only the dimension with the smallest number of members as rows in one column and their corresponding values as rows in the adjacent column. All other dimension will be marked in an associated dimension tree. If the selected qualified item set includes two or more dimension having a number of members that satisfied the default cutoff or user defined display cutoff, then the dimension with the fewest members will be displayed on the y-axis (columns) of the cross-tab and dimension with the second fewest members will be displayed on x-axis (rows) of the cross-tab. This method allows the user to analyze the qualified item sets without having to port the result to a different program for post processing or more commonly to extract the item set information and manually analyze the data within each item set.

The present invention also provides a method for refining anti-monotone searching including the steps of set forth above and further including user analysis of the results, which the user uses to refine the original search and the method is repeated until the user is satisfied with the results generated by the method.

The present invention also provides a method for capturing the search and search refinements and producing a heuristic rules that the method can provide to the user during search space selection and/or search construction.

Depending on the report filters, the results of the method can report all item sets that satisfy each constraint individually or collectively, where the preferred report displays only those item sets that satisfy all constraints.

Although the use of the use of qualifiers or secondary constraints and must-include constraints are described with reference to the present method, these types of constraints are applicable to any data-mining algorithm.

The present invention also provide a display construct including two or more Pareto diagrams related to data in a qualified item set generated using the method of this invention or generated using any other data-mining method.

### DESCRIPTION OF THE DRAWINGS

The invention can be better understood with reference to the following detailed description together with the appended illustrative drawings in which like elements are numbered the same:

FIG. 1A depicts a cross-tab showing the dimension Gender, its members and associated total measure values;

FIG. 1B depicts a cross-tab showing the dimension Education Level, its members and associated total measure values;

FIG. 2A depicts a conceptional flow chart of a preferred method of this invention;

FIG. 2B depicts a conceptional flow chart of another preferred method of this invention;

FIG. 2C depicts a conceptional flow chart of another preferred method of this invention;

FIGS. 3A-C depict three cross-tabs showing the Educational Level, Product Family, and Gender dimensions, their members and associated total measure values;

FIGS. 3D-F depict three 2-dimensional cross-tabs showing combinations of the dimension of FIGS. 3A-C, their associated members and corresponding total measure values;

FIG. 3G depicts 3-dimensional cross-tabs showing combinations of all of the dimension of FIGS. 3A-C, their associated members and corresponding total measure values;

FIG. 3H depicts a results screen after the method of this invention has been applied to the data of FIGS. 3A-G using the constraint measure Profit >$100,000;

FIG. 4A depicts a tool bar including a bottom to invoke the method of this invention;

FIG. 4B depicts a measures selection screen of a wizard associated with the implementation of the method of this invention in a windowing operating system environment;

FIG. 4C depicts a rule selection screen of the wizard displaying a rule construction drop down menu;

FIG. 4D depicts a dimension selection screen associated with the wizard;

FIG. 4E depicts an optional must-include member selection screen associated with the wizard;

FIG. 4F depicts an optional filter member selection screen associated with the wizard;

FIG. 4G depicts a search conditions selection screen associated with the wizard;

FIG. 4H depicts a supplemental search conditions selection screen associated with the wizard;

FIG. 4I depicts a search condition limits selection screen associated with the wizard of FIG. 4B;

FIG. 4J depicts an optional select and/or deselect screen associated with the wizard;

FIG. 4K depicts a first results screen after running the search constructed in FIG. 4B-I;

FIG. 4L depicts a second results screen after running the search constructed in FIG. 4B-I;

FIG. 5 depicts a screen showing the integration of a Pareto Chart and a cross-tab;

FIG. 6 depicts the screen of FIG. 5 with mouse activated information;

FIG. 7 depicts the screen of FIG. 5 with an accumulator;

FIG. 8 depicts the screen of FIG. 5, with slider adjustment;

FIG. 9A depicts the screen of FIG. 8 activating a hide function;

FIG. 9B depicts the screen of FIG. 9A after hide function activation;

FIG. 10 depicts the screen of FIG. 5 with mouse cell activation;

FIG. 11 depicts the screen of FIG. 5 with traffic lights descriptors and target lines activated;

FIG. 12 depicts the screen of FIG. 5 with the column Pareto chart hidden;

FIG. 13 depicts a screen with an added dimension to form a 3D cross-tab with three associated Pareto charts;

FIG. 14 depicts the screen of FIG. 13 with the column Pareto chart hidden;

FIG. 15 depicts the screen of FIG. 13 with hidden column; and

FIGS. 16A-C depict are property dialog for target line and traffic light functionality.

### DETAILED DESCRIPTION OF THE INVENTION

The inventor has found that a straightforward and efficient methodology can be constructed for generating multidimensional summary reports from multidimensional data by applying at least one anti-monotonic constraint for efficient search space pruning, optionally one or more secondary constraints or conditions such as other measure constraints, other anti-monotonic constraints, must-include constraints or the like and optionally data filters to generation of candidate data member that satisfy a primary search criterion, any secondary search criteria and any filters. This methodology provides a direct, simple and efficient methodology for culling through large amounts of data to locate data of interest to a user or to locate data exceptions. The methodology can be used to generate reports at any level of item set that satisfy a given search.

The data and data exception finder methodology of this invention makes use of an important property of aggregated data to drastically reduce the search space during a user constructed search, some of the data will of course represent data anomalies, while other data will simply be of interest to the user if a set cannot pass a test, all of its supersets will fail the same test as well. This property has been widely used in the Apriori algorithm for the generation of “Association Rules.” This property belongs to a special category of properties called anti-monotone properties. These properties are called anti-monotone because the property is monotonic with respect to failing a test.

In the context of Market Basket Analysis, anti-monotonic properties have been successfully used in order to reduce the search space for analyzing frequent item sets. The property is known as an Apriori property: all non-empty subsets of a frequent item set must be frequent. This property is based on the following observation: since all item sets adopt the same minimum support threshold, if an item set I is not frequent, i.e. Prob {I}<minimum support, then an item set formed by adding an item i to the item set I cannot occur more frequent than I alone. Thus, giving rise to the general rule: Prob{i∪{I}}<minimum support. This property allows the Apriori algorithm to prune away a significant number of candidate sets that would have otherwise required computing.

By using anti-monotonic property, the search space in finding frequent combinations of items is more efficiently achieved. In this way, the Apriori algorithm can employ an iterative approach to construct frequency trees: first frequent itemsets having only one item are found (1-itemsets). The 1-itemset are then used to find itemsets including a combination of two 1-itemsets (2-itemsets). 1-itemsets and/or 2-itemsets are then used to find 3-itemsets (itemsets including a combination of three 1-itemsets), and so on until no higher frequent k-itemsets can be found. For additional information on Aprior the readers is referred to U.S. Pat. Nos.: 6,003,029; 6,278,997 and 6,324,533, incorporated herein by reference.

Extending this methodology using anti-monotonicity properties to data-mining, a new, efficient method to automatically find exceptions that satisfy at least one anti-monotone constraint can be created. This method is sometimes referred to herein as the Summary Method.

The simple description of anti-monotonicity is: if a set S violates a given constraint, any superset of S will also violate the constraint. Formally, a constraint, C, is anti-monotone if and only if for all sets S and S, S⊃S and S satisfies C=>S satisfies C.

For example, let's analyze the following exception condition or constraint, a very common constraint in OLAP data analysis: find all data satisfying the condition that a value of a measure is GREATER THAN OR EQUAL TO a threshold value. It can be proven that if a set I, where I is composed of a combination of members from different dimensions in an OLAP cube, doesn't satisfy the condition Measure ≧threshold, then, by adding a new member of another dimension in the OLAP cube to the set I to create a new set Iₙ, Iₙ will also violate the Measure ≧threshold condition or constraint. This behavior is true for all data organized in into an OLAP data cube, i.e., aggregated data.

Suitable computers for use with the method if this invention include without limitation any digital or analog processing unit or a combined digital/analog processing unit including a processing unit for executing instructions, memory, mass storage devices, peripheries, communication hardware or any other hardware generally associated with computers. Suitable digital processing units (DPUs) include, without limitation, any digital processing unit capable of executing the code encoding the methods of this invention. Exemplary examples of such DPUs include, without limitation, system manufactured by Intel, AMD, Silicon Graphics, Samsung, TI, HP, IBM, Cyrix, Motorola, or any other manufacturer of microprocessors. Suitable analog processing units (APUs) include, without limitation, any analog processing unit capable of of executing the code encoding the methods of this invention.

Suitable operating systems and software include windowing and non windowing operating system, but windowing operating systems are preferred. Exemplary operating systems include, without limitation, Windows operating system from MicroSoft, OS operating systems from Apple, Unix type operating system such as LINUX or any other windowing operating systems. Application software that are useful, necessary or suitable include OPEN GL graphics library, OLAP software, communication software, database software, programming software or the like.

The following example illustrates the of the methodology of this invention to a specific data-mining problem.

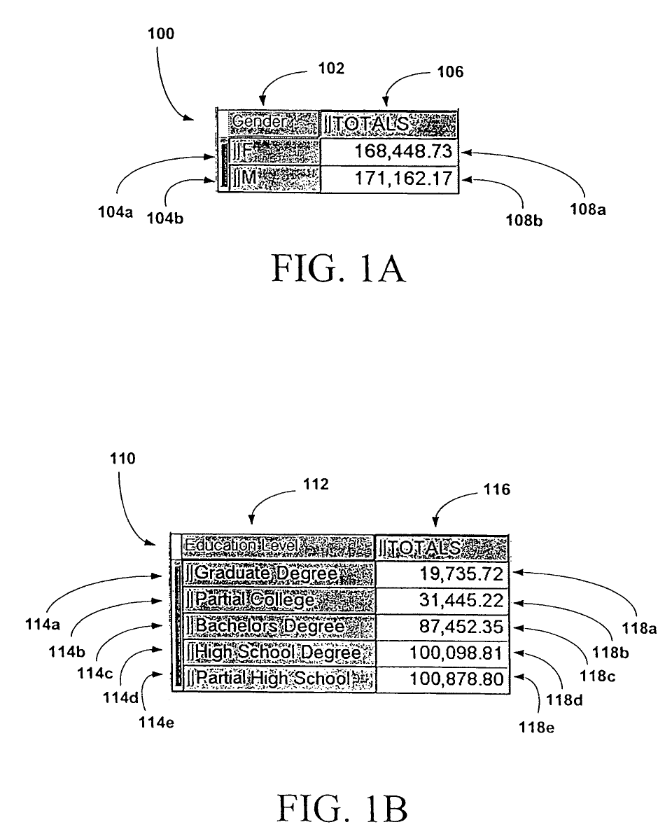

A customer retail OLAP cube includes two dimensions Gender and Educational Level and a measure Profit. Referring now to FIG. 1A, a cross-tab 100, is shown depicting a Gender column 102 having member rows 104a&b (F and M, respectively) and totals column 106 having totals 108a&b of the measure Profit associated with each member 104.

Referring now to FIG. 1B, a similar cross-tab 110 is shown to include an Education Level column 112 having members 114a-e (Graduate Degree, Partial College, Bachelors Degree, High School Degree, and Partial High School, respectively) and a Totals column 116 having totals 118a-e of the measure Profit associated with each member 114.

Suppose a user wanted to extract all combinations having a Profit value greater than $90,000, by applying the above general rule relating to anti-monotonic constraints, the search space can be quickly reduced because the method does not need to calculate all possible combinations, but only those combinations including members that satisfy the constraint, Profit >$90,000. A quick visual review of FIGS. 1A&B shows that three members can be immediately discarded from the Educational Level dimension: Graduate degree; Partial College degree; and Bachelors Degree, because these three member do not satisfy the constraint.

Hence, the method need only look at combinations of the remaining members of the dimension Educational Level with the other selected dimension levels that satisfy the constraint. This search space pruning is possible because the condition “Greater Than” is anti-monotone in the sense that if the member Graduate Degree violates the greater than $90,000 condition, then any superset including the member Graduate Degree (e.g., Graduate Degree and M) will also violate the condition.

The Summary method of the present invention broadly relates to the use of the properties of anti-monotonic constraints to reduce the search space and permit a more efficient process for finding desired data and/or data exceptions.

The Summary method needs as input an n-dimensional data cube, D, and an anti-monotone constraint or condition, C. The method outputs a set of inter-dimensional tuples (desired data and/or data exceptions) constructed from the n dimensions of D that satisfy C.

The Summary method of this invention includes the steps of:

selecting a set of dimensions associated with the cube, D;

selecting a measure associated with the cube, D;

specifying at least one measure constraint, condition or rule, C;

for k=1, generating candidate 1-item sets for each selected dimension;

identifying and pruning all 1-item set candidates that violate C to produce a set of 1-item sets having a measure value that satisfies C;

for k=k+1, generating candidate k-item sets comprising a combination of (k−1)-item sets;

pruning all k-item sets including at least one 1-item set having a measure value that violates C to form a set of k-item sets comprising combinations of (k−1)-item sets that satisfy C;

repeating the last two steps until no higher dimensional combinations are possible.

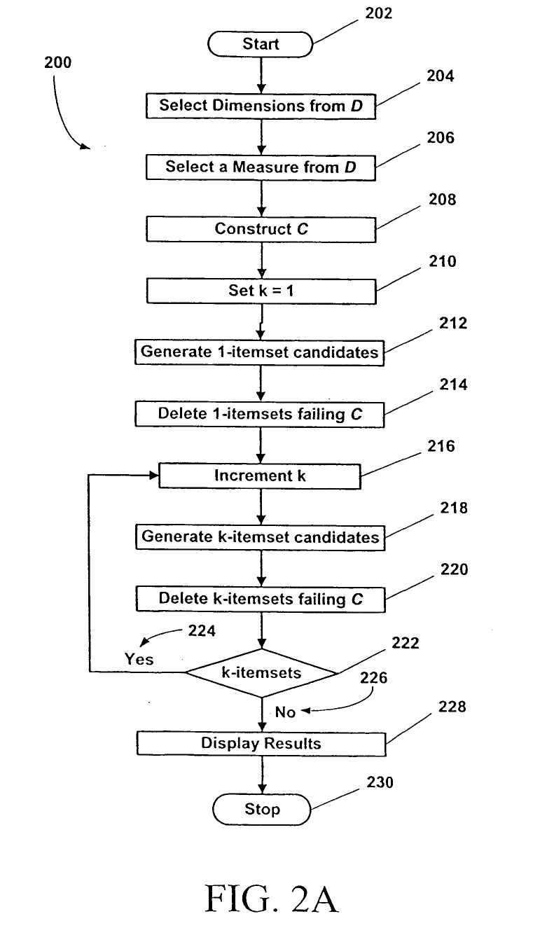

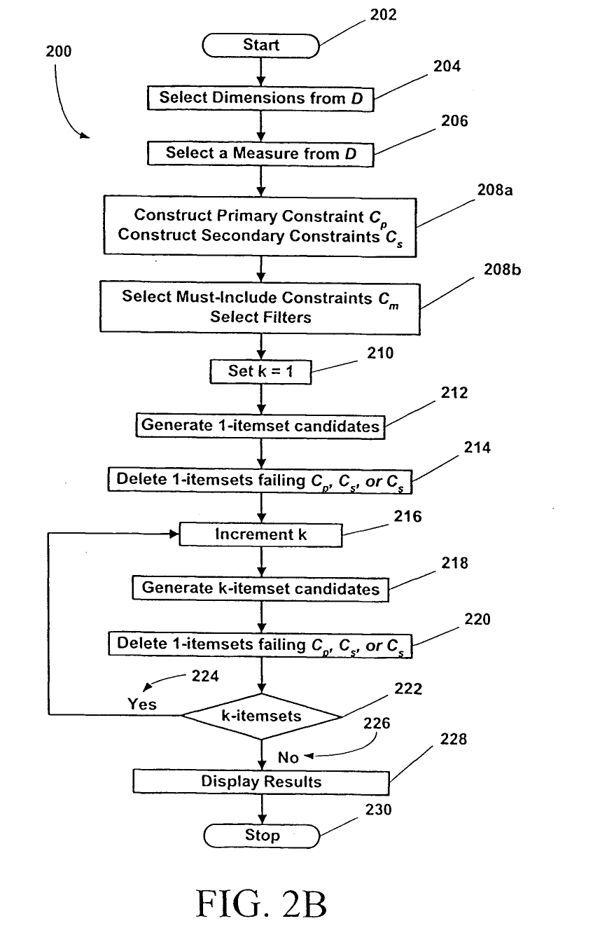

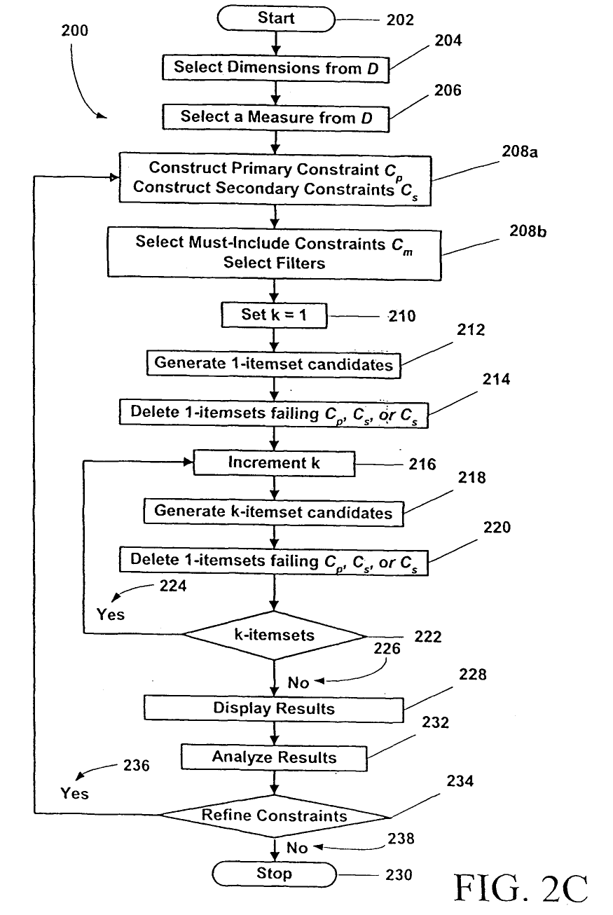

Referring now to FIG. 2A, a conceptual flow chart; 200, is shown to include a start step 202 followed by a select dimension step 204, where a user selects a set of dimensions from an n-dimensional OLAP cube, D, to which the method will be applied. The user also selects a measure from D in a second select step 206. Next, the user constructs a constraint C that will act as the primary search criterion in a construct step 208. After all the method initialization steps have been performed, the method sets a counter k equal to 1 in a set step 210. The method then generates all 1-item sets (all members of each selected dimension) in a first generate step 212. The method then deletes all 1-item sets that do not satisfy C in a first delete step 214. Next, the counter k is increments in increment k step 216. The method now generates all k-item sets in a second generate step 218 formed from combinations of all (k−1)-item sets that satisfied C at this level of iteration. Again, the method deletes all k-item sets that do not satisfy C in a second delete step 220. The method then checks to see if any of the k-item sets satisfy C in a test step 222. If at least one k-item set satisfies C, then control is transferred along a YES branch 224 to the increment step 216. Otherwise, control is transferred along a NO branch 226 to a display results step 228 and then to a stop step 230.

Referring now to FIG. 2B, a conceptual flow chart, 200, is shown to include a start step 202 followed by a select dimension step 204, where a user selects a set of dimensions from an n-dimensional OLAP cube, D, to which the method will be applied. The user also selects a measure from D in a second select step 206. Next, the user constructs a primary constraint Cₚ and one or more secondary constraints Cₛ that will act as the primary search criterion and secondary search criteria in a construct step 208a. Next, the user selects one or more must-include dimensions or dimension members Cₘs and selects one or more filters in a select step 208b. After all the method initialization steps have been performed, the method sets a counter k equal to 1 in a set step 210. The method then generates all 1-item sets (all members of each selected dimension) in a first generate step 212. The method then deletes all 1-item sets that do not satisfy the constraints in a first delete step 214. Next, the counter k is increments in increment k step 216. The method now generates all k-item sets in a second generate step 218 formed from combinations of all (k−1)-item sets that satisfied constraints at this level of iteration. Again, the method deletes all k-item sets that do not satisfy constraints in a second delete step 220. The method then checks to see if any of the k-item sets satisfy constraints in a test step 222. If at least one k-item set satisfies constraints, then control is transferred along a YES branch 224 to the increment step 216. Otherwise, control is transferred along a NO branch 226 to a display results step 228 and then to a stop step 230.

Referring now to FIG. 2C, a conceptual flow chart, 200, is shown to include a start step 202 followed by a select dimension step 204, where a user selects a set of dimensions from an n-dimensional OLAP cube, D, to which the method will be applied. The user also selects a measure from D in a second select step 206. Next, the user constructs a primary constraint Cₚ and one or more secondary constraints C_{s that will act as the primary search criterion and secondary search criteria in a construct step 208}a. Next, the user selects one or more must-include dimensions or dimension members Cₘs and selects one or more filters in a select step 208b. After all the method initialization steps have been performed, the method sets a counter k equal to 1 in a set step 210. The method then generates all 1-item sets (all members of each selected dimension) in a first generate step 212. The method then deletes all 1-item sets that do not satisfy the constraints in a first delete step 214. Next, the counter k is increments in increment k step 216. The method now generates all k-item sets in a second generate step 218 formed from combinations of all (k−1)-item sets that satisfied constraints at this level of iteration. Again, the method deletes all k-item sets that do not satisfy constraints in a second delete step 220. The method then checks to see if any of the k-item sets satisfy constraints in a test step 222. If at least one k-item set satisfies constraints, then control is transferred along a YES branch 224 to the increment step 216. Otherwise, control is transferred along a NO branch 226 to a display results step 228. Next, the user can analyze the data in an analyze results step 232, where the user can look at the results using statistical techniques, adding other dimension or dimension members to the results to determine the effects of these refinements on the results. Next, the user is asked if the user wants to modify the search criterion in a refine search step 234. If refinement is desired, then control is transferred along a YES branch 236 to the construct step 208a. Otherwise, control is transferred along a NO branch 238 and then to a stop step 230. The method may also include a record step and a create heuristics step prior to the stop step 230.

To illustrate these methods, consider the following example. The user wants to find interest data relating to profit, the measure, for the combinations of the following dimensions: Education Level, Product, and Gender, with respect to a primary constraint: profit >$100,000.

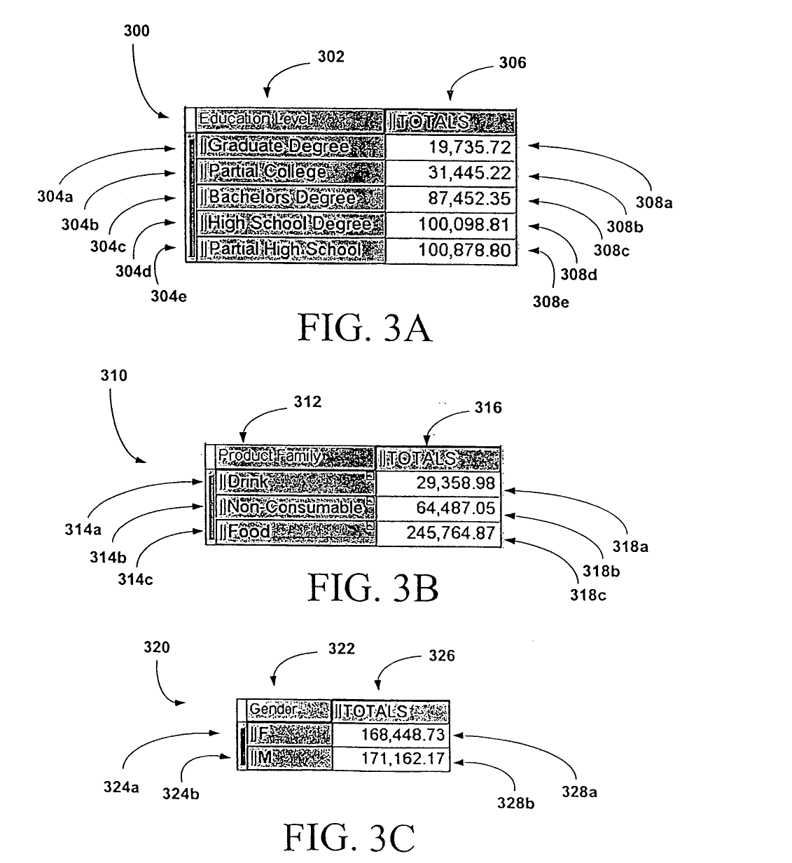

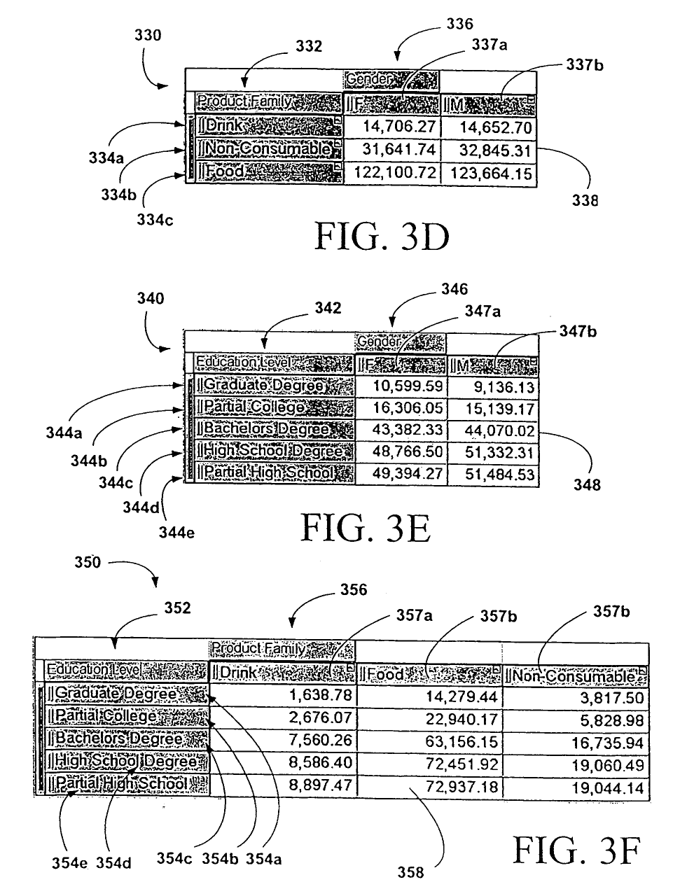

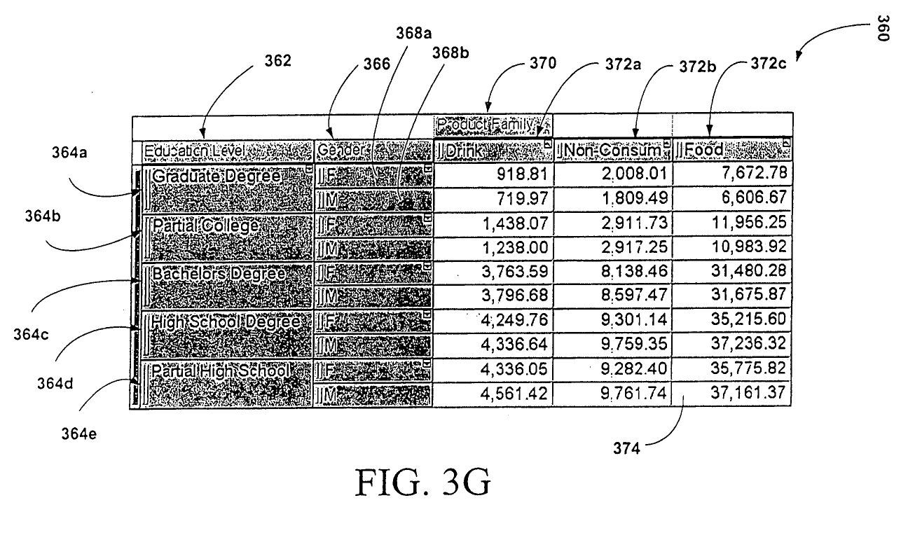

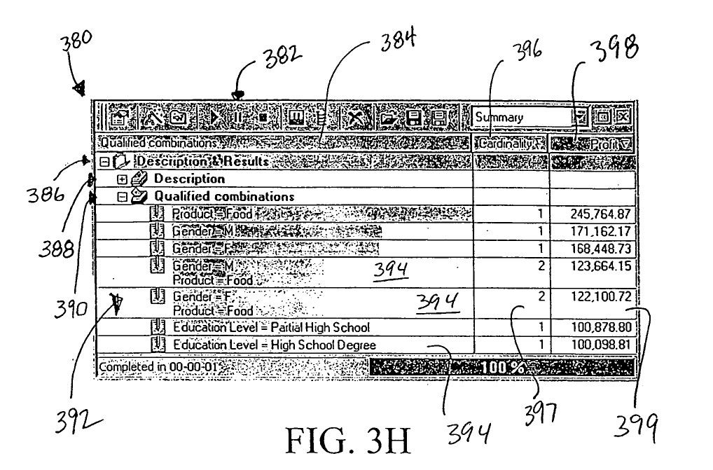

Looking at all one dimensional item sets, there are ten item sets (Education Level=5, Product=3, and Gender=2) and their corresponding measure values as shown in FIGS. 3A-C. Looking at FIG. 3A, a cross-tab 300, is shown to include an Education Level column 302 having members 304a-e (Graduate Degree, Partial College, Bachelors Degree, High School Degree, and Partial High School, respectively) and a Totals column 306 having totals 308a-e of the measure Profit associated with each member 304. Looking at FIG. 3B, a cross-tab 310 is shown depicting a Product Family column 312 having member rows 314a-c (Drink, Non-Consumable and Food, respectively) and totals column 316 having totals 318a&b of the measure Profit associated with each member 314. Looking at FIG. 3C, a cross-tab 320 is shown depicting a Gender column 322 having member rows 324a&b (F and M, respectively) and totals column 326 having totals 328a&b of the measure Profit associated with each member 324.

Looking now at all two dimensional item sets, there are 31 possible item sets (Gender and Product 2*3=6, Gender and Education Level 2*5=10, Education Level and Product 5*3=15) and their corresponding values as shown in FIGS. 3D-F. Looking at FIG. 3D, a 2D cross-tab 330 is shown to include an Product Family column 332 having members 334a-c (Drink, Non-Comsumable , and Food, respectively), a Gender header column 336 having members 337a-b and totals 338 of the measure Profit associated with each pair of members 334a-c and 337a-b. Looking at FIG. 3E, a 2D cross-tab 340 is shown to include an Educational Level column 342 having member rows 344a-c (Graduate Degree, Partial College, Bachelors Degree, High School Degree, and Partial High School, respectively), a Gender header column 346 having members 347a-b and totals 348 of the measure Profit associated with each pair of members 344a-c and 347a-b. Looking at FIG. 3F, a 2D cross-tab 350 is shown depicting an Educational Level column 352 having member rows 354a-c (Graduate Degree, Partial College, Bachelors Degree, High School Degree, and Partial High School, respectively), an Product Family header column 356 having members 357a-c (Drink, Non-Comsumable, and Food, respectively) and totals 358 of the measure Profit associated with each pair of members 354a-c and 357a-c.

Looking now at all three dimensional item sets, there are 30 possible item sets (Gender and Product and Education Level 5*3*2=30) and their corresponding values as shown in FIG. 3G. Looking at FIG. 3F, a 3D cross-tab 360 is shown to include an Educational Level column 362 having member rows 364a-c (Graduate Degree, Partial College, Bachelors Degree, High School Degree, and Partial High School, respectively), a Gender column 366 having members 368a-b, an Product Family header column 370 having members 372a-c (Drink, Non-Comsumable , and Food, respectively) and totals 374 of the measure Profit associated with each combination of members 364a-c, 368a-b, and 372a-c. Thus, there is a total of 10+31 +30=71 item sets that would have to be evaluated using a brute force evaluation process. Manually, it can determined that there are 7 values out of 71 that satisfy the profit search criterion “Greater Than $100,000.”

Referring now to FIG. 3H, the result obtained by using the method of this invention took only about one second to process, because the method was able to eliminate all members having a value of the measure less than $100,000 and all item sets that would include the elements until no item set satisfied the condition. Looking at FIG. 3H, a results screen 380 is shown to include a tool bar 382, a column of qualified combinations 384 including a Decription & Result expansion row 386, a Description expansion subrow 388, and a Qualified combinations expansion subrow 390 showing a list 392 of qualified combinations 394 defined with respect to the member combinations that satisfied the anti-monotone condition Profit>$100,000. The screen 380 also includes a cardinality Column 396 having values 397 and a Profit column 398 having values 399.

From a review of the results, the method applied the condition Profit>$100,000 and found only one-dimensional and two-dimensional exceptions (item sets that satisfied the condition); while the rest of the combinations were earlier discarded by the method because of the anti-monotonic condition “greater than.”

In the context of OLAP data analysis or mining, the method of this invention performs significantly better than when the method is applied to other type of database such as relational databases or flat files. This fact is true because the data in an OLAP database is aggregated, i.e., certain measure values are pre-calculated and the data is efficiently stored in multidimensional data structures called a cube. Cubes are explicitly designed to support a fast and efficient data retrieval mechanisms. In practice, this means that retrieving a set of combinations of different members from several dimensions (cross tab) is carried out by the OLAP engine by means of a very simple query, while it would require several queries and aggregation operations in a relational database. In addition, OLAP is able to manage information at different levels of hierarchies, allowing the combination of members at different levels of details, while keeping the same performance efficiency. By taking advantage of these OLAP characteristics, the knowledge discovery process can be efficiently carried out, discovering hidden relationships in the data that is difficult to see otherwise.

It is important to note that any anti-monotonic condition can be used in the methods of this invention to find all possible combinations of dimensions members that satisfy the condition. Each condition will be known as “exception condition.” A non-exhaustive list of anti-monotonic conditions includes: Greater than (>), Greater than or equal (≧), Less than (<), Less than or Equal to (≦), Between (><), Not Between (<>), Equal to (=), Not Equal to (≠), N Top Values, N Bottom Values, N % Top Values, N % Bottom Values, or the like or mixtures or combinations thereof or any combination of these condition interconnected by a Boolean operator. Any other conditions that satisfy the anti-monotone property can also be used in this context. For example, the “Top Ten” condition allows the creation of the 10 most significant combinations of members from the search space. This type of monotonic condition can help in the discovery of significant information. For example, the classical usage of a “top ten” report is to generate list such as the Top ten parts that fail the most, the Top ten products that sell the most, the Top ten sale persons, the Top ten stores or the Top ten customers.

However, the classical solution of finding the most prominent combinations of any of the members of the above mentioned dimensions (parts, products, sale persons, stores and customers) is at best inefficient, difficult and very time-consuming task. The methods of this invention deal well with this type of problem, allowing the user to select and extract the most prominent combinations efficiently, easily and very quickly.

At the end of the execution of the method of this invention, a set of multidimensional exceptions are returned, some of which are hopefully what the user is looking for, but in practice the user might only be interested in a reduced set of exceptions containing one or more conditions defined apriori. Therefore, it is also a subject of the present invention to be able to pre-defined constrains to the exception generation process in such a way that the method is forced to find only those tuples (n-dimension item sets) that satisfy the given constraints (soundness property); while at the same time guarantying that all tuples satisfying the predefined constraints are found (completeness property). An example of such constraint is a so-called “must-include” constraint or condition. A must-include conditions comprises a dimension or dimension member that must be present in all qualified item sets. Thus, a must-include condition forces the method to find only tuples that include the must-include dimension or dimensional members. These restrictions are imposed during method processing and not as a post-processing step, a classical data mining systems. Additionally, due to the fact that OLAP cubes contains a set of pre-calculated measures, the method can use any one of these pre-calculated measures in the exceptions discovery process without sacrificing computational performance. In fact, this feature has the ability to reduce the search space and hence enhance method performance.

One aspect of the novelty of the methods of this invention lies in the fact that by using a simple property present in the aggregated data in OLAP cubes, the method can be used of automatically detect anomalies in a selected data space. The types of exceptions that can be generated by using the methods of this invention are of special interest for many industrial and market applications.

The Method in Detail

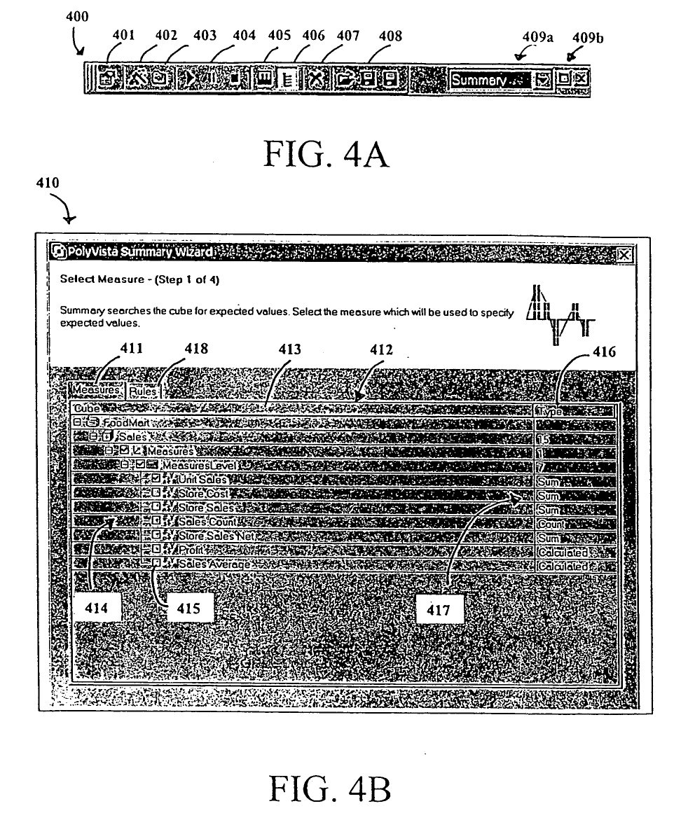

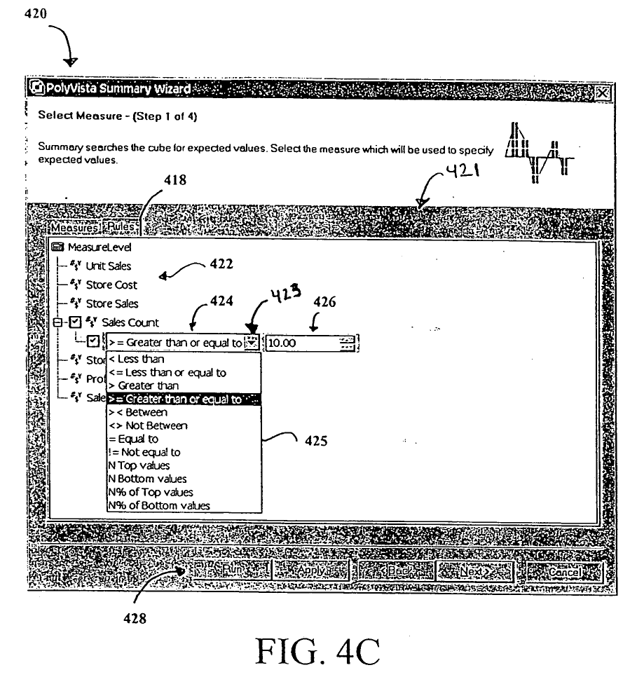

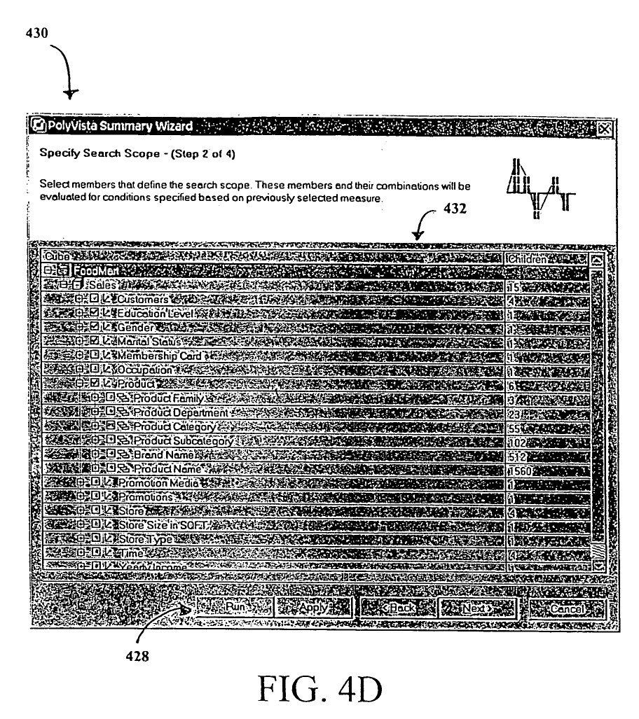

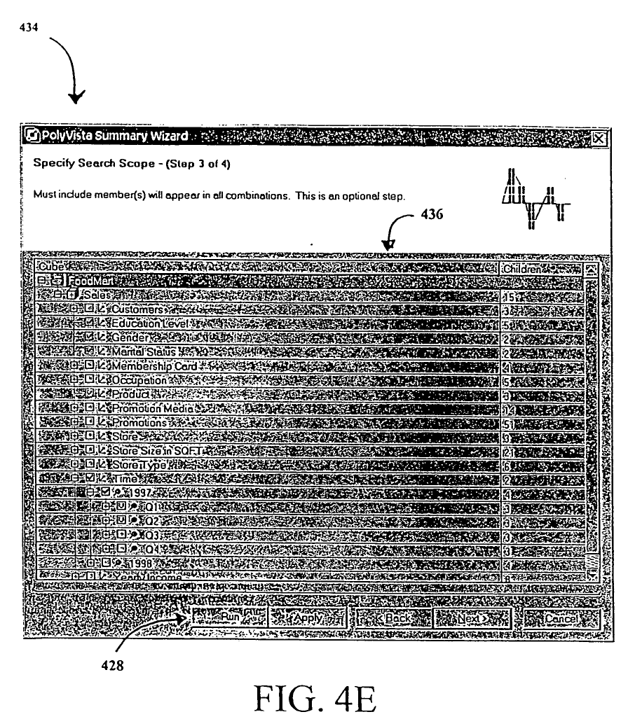

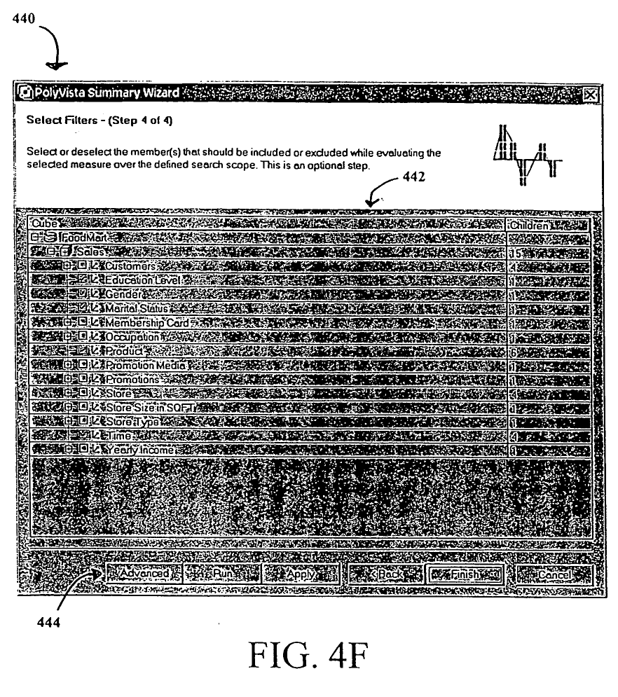

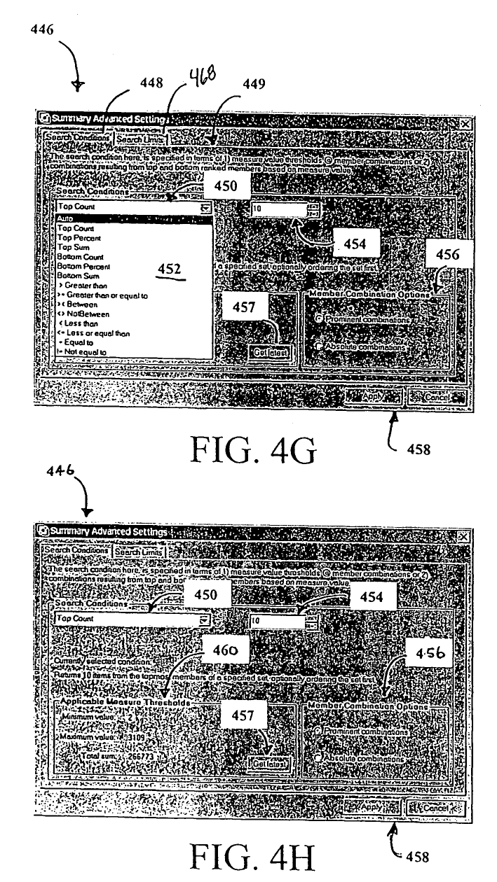

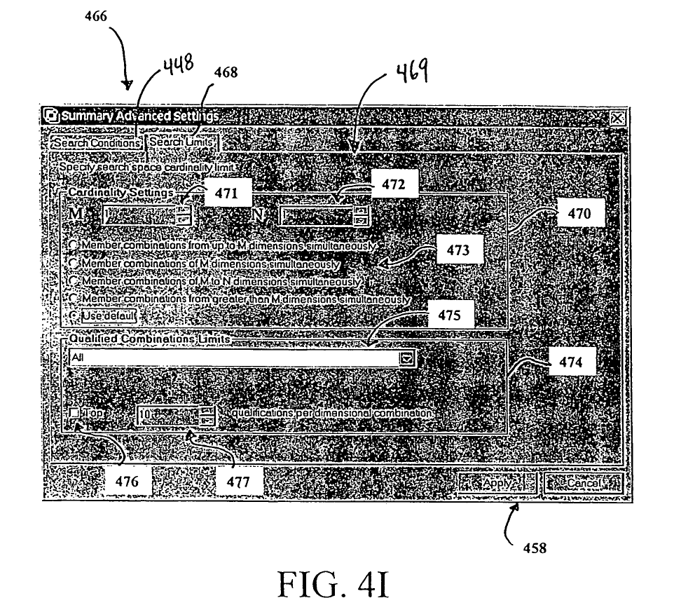

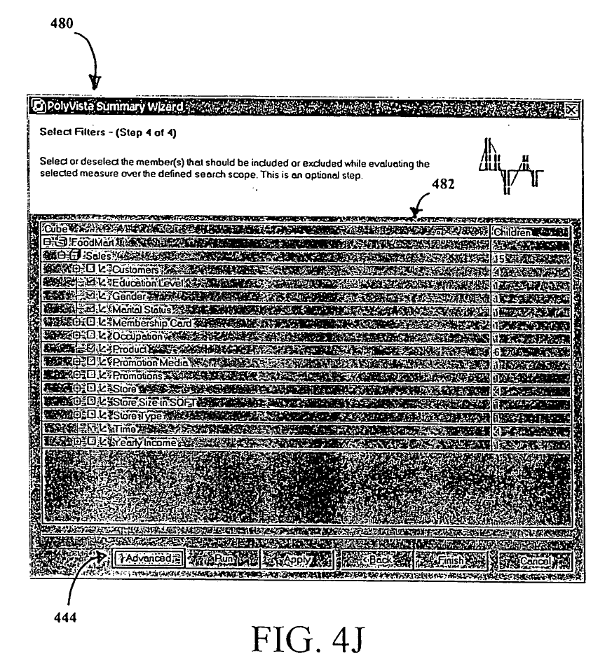

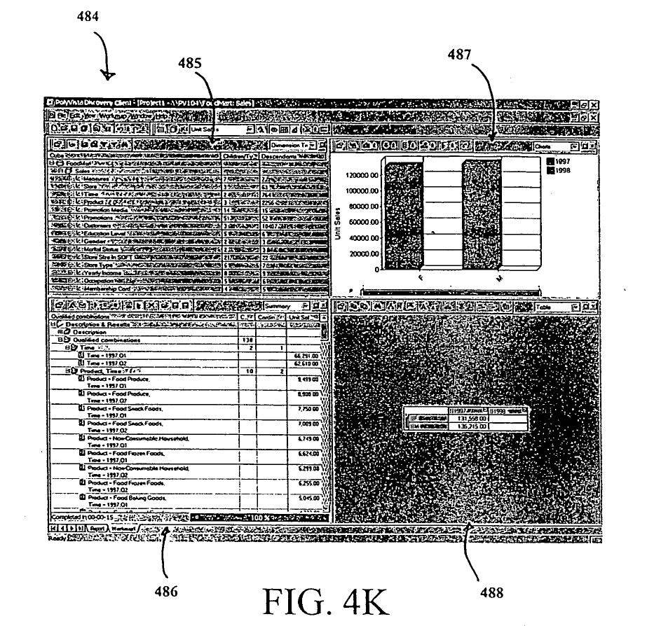

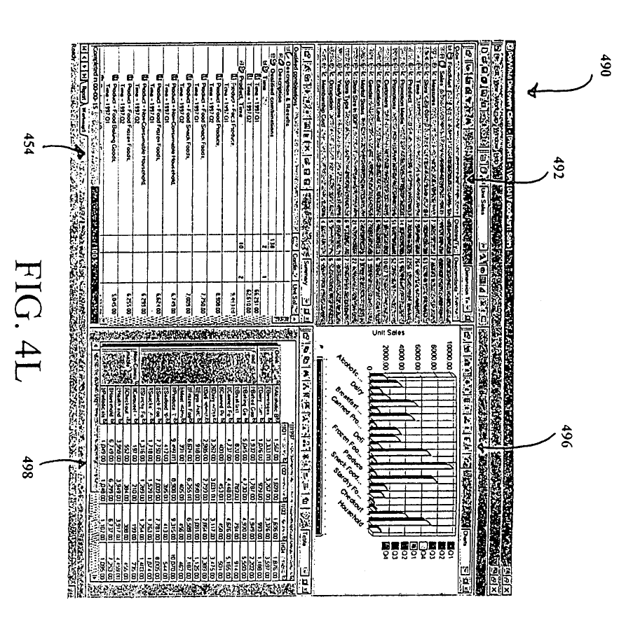

The Summary method of this invention can be configured using a common wizard dialog sequence. A wizard is a common programmatic construct for leading a user through a process using a sequential set of interactive controls. Referring to FIG. 4A, a tool bar 400 is shown to include the following buttons: Discovery Pane property sheet button 401; Summary Configuration Wizard Startup button 402; Configure the Algorithms Advanced settings button 403; Standard Algorithm controls button 404 for Run, Pause and Stop; Pause or Resume Combination Display button 405 (while the algorithm is running and adding new results to the result listing, you can optionally turn off the display of new members and then resume displaying them when desired); Show/Hide the Result Hierarchy button 406 (Group or not group by common members); clear current results button 407; and Standard Algorithm controls button 408 for Importing/Exporting XML: Import—open and read in a Discovery XML file; Export Settings—Export the Discovery settings or configuration information; Export Settings and Results; Export Settings and current result information. The tool bar 400 also includes a pull down menu button and associated window 409a and screen controls button 409b.

To invoke the wizard and begin the method configuration process, the Wizard Startup button 402 is clicked and the interactive dialog control screen 410 is displayed as shown in FIG. 4B. The first step in the configuration process asks the user to select a measure of interest from a measure tab 411 a measure window 412 having a cube column 413 including a measure tree 414 with associated check boxes 415. The users selects a measure by clicking on one of the check boxes 415. In this case, Unit Sales measure has been selected. The window 412 also includes a Type column 416 having associated descriptors 417. FIG. 4B also shows that the interface supports the concept of Measure Rules as evidence by a Rules tab 418.

These optional applied rules can be defined by clicking the Rules tab 418. Measure rules provide the user with a means to limit the result set based on specific criteria applied to one or more measures. This is particularly useful for measure that are a ratio of two other measures. For example, assume the selected measure is Average Sales (Sales divided by Sales Count). Averages can be very misleading when the number of samples is very small. By using measure rules, the user can specify that Sales Count must be greater than sum cutoff such as 10, thus, ensuring a reasonable sample size for the average.

Referring to FIG. 4C, a rule definition screen 420 is shown to include a rules tab window 421 including a list of Measure Level list 422, where the Sales Count level has been selected activating a pull down or drop down menu 423 and associated display window 424. The menu 423 produces a rule template list 425. From the drop-down list 425 you can select an appropriate operator as well as a target value in a target value definition window 426. It is possible to define one or more rules on any specific measure, just click on the measure of interest. Multiple rules can be associated with multiple measures and multiple rules per measure are allowed. The wizard is advanced by pressing the NEXT button associated with control buttons 428. The control buttons 428 will highlight on those buttons that are active in the particular wizard window.

Referring to FIG. 4D, a Search Scope definition screen 430 is shown having a database dimension schema window The wizard is advanced by pressing the NEXT button associated with control buttons 432, which represents step 2 of the wizard definition process. The user selects one or more dimensions and/or dimension levels that will be used by the method to identify item sets that satisfy the search criteria. In this example, Education Level, Gender, Marital Status and Product have been selected (check boxes). Product is a hierarchical dimension, and only the Product Category level of the Product hierarchy has been selected. The method takes advantage of the hierarchical properties of the multi-dimensional database allowing the user to select an entire dimension, level or any subset thereof. Selecting levels in hierarchical data is much more difficult if the source data is contained in a flat file or relational database increasing processing overhead. The wizard is advanced by pressing the NEXT button associated with control buttons 428. It should be noted that the method can be run at this point by clicking the RUN button.

Step 3 of the wizard definition process allows the user to optionally specify any particular dimensions or dimension members to be must-include constraint, i. e., the dimension or dimension member must be present result combinations. This step allows users to influence the discovered results drawing on their own expertise. Looking at FIG. 4E, a must-include selection screen 434 is shown to include a selection window 436. Here Time, 1997, Q1 and Q2 have been selected as must-include constraints. The wizard is advanced by pressing the NEXT button associated with control buttons 428. It should be noted that the method can be run at this point by clicking the RUN button.

Step 4 of the Summary Wizard definition process allows the user to optionally further constrain the search space by defining one or more filters. For example, the user could restrict this method to search only Stores in California by expanding the Stores dimension and selecting only California (CA). Alternately, the user could restrict this method to search only transactions that occurred in the first two quarters of 1997 by expanding the Time dimension and selecting the appropriate quarters. Filters can substantially decrease the search space and thus greatly speed up the discovery process. Looking at FIG. 4F, a filter definition screen 440 is shown to include a selection window 442. The wizard is advanced by pressing the ADVANCED button associated with expanded control button set 444. It should be noted that the method can be run at this point by clicking the RUN button or the definitional process can be stop by clicking on the FINISH button.

The final configuration settings deal with selecting the Search conditions and Limits, as shown in FIGS. 4G-I. Looking at FIG. 4G, an advanced setting screen 446 is shown to include a Search Conditions tab 448 and a Search Limits tab 468. The Search Conditions tab 448 is active in this figure including a setting window 449. The window 449 includes a pull down menu 450 of monotone functions liste in a menu list 452. The window 449 also includes a value definition window 454. The window 449 also includes a member combinations option window 456 and a get latest button 457. Finally, the screen 446 includes control buttons 458.

From the Search Conditions tab 448, the user defines the criteria for the desired type of exception. In this example, the search criteria is a “Top Count” or Top N where N defines the maximum number values to return.

Referring to FIG. 4H, after an advanced criterion has been selected, the screen 446 displays a thresholds window 460 which displays the range of values that the previously selected measure spans. In the section called Member Combination Options 456, the “Prominent Combination” option means that the result lists of higher cardinality exceptions are based on the ranked results of lower cardinality queries. The “Absolute Combinations” option means that the exception results are based on an evaluation of combinations including all specified dimension members.

FIG. 4I depicts the Search Limits screen 466 and exposes two additional configurable parameters. The Search Limits are like a post processing step applied to the results list. The screen 466 includes a Cardinality Settings window 470 including an M definition box 471, an N definition box 472 and member combination options 473. M and N limits the number (or sets a range of limits) of different dimensions that are to be represented in the results list. The screen 466 also includes a Qualified Combinations Limit window 474 including a pull down menu 475, a Top selection box 476 and a qualifications per dimensional combination definition box 477. The Qualified Combination Limit window 474 allows the user to specify various ways to limit the number of result entries per list. The wizard is advanced by pressing the APPLY button associated with expanded control button set 458.

After all desired search definitional constraints and filters have been applied, a final configuration screen 480 as shown in FIG. 4J is displayed including a the database schema window 482, where the user can decide to add additional constraints or modify the constraints already made. The method is run by pressing the RUN button associated with the control set 444.

Referring now to FIG. 4K, a results screen 484 is shown to include a search configuration pane 485, a results pane 486, a graphics pane 487 and a cross-tab pane 488. As the method runs, the results are displayed in the results pane 486 as generated. A very important feature of the method is the ability drag and drop individual results from the result list in the results pane 485 onto the cross-tab pane 488, where a 2D-Gender-Time cross-tab has been dropped. This unique feature of the method permits the user to immediately begin exploring and validating the results.

Referring now to FIG. 4L, a results screen 490 is shown again to include a search configuration pane 492, a results pane 494, a graphics pane 496 and a cross-tab pane 498. FIG. 4L shows the result of selecting the Product=Food.Produce, Time=1997.Q1 result and dragging & dropping that result on the cross-tab pane 498.

Although many of the aspects of this invention have been illustrated using the summary data mining method of this invention, many of these aspects, especially, the anti-monotonic constraints strategies can be adapted to run with any data mining methods including those described in U.S. Pat. Nos.: 6,003,029; 6,278,997 and 6,324,533; U.S. patent application Ser. No: 09/713,674 filed 15 Nov. 2000 and Ser. No. 09/811,008 filed 16 Mar. 2001 and PCT Application designating the U.S. Ser. No. PCT/US02/19541 filed 19 Jun. 2002, incorporated therein by reference.

The user can apply this ratio in a number of ways: (1) Addressing the most troublesome 20 percent of the problem will solve 80 percent of it; (2) Within a specified process, 20 percent of the individuals will cause 80 percent of the headaches; (3) In public involvement, 20 percent of the people will command 80 percent of the user's time; (4) Of all the solutions the user identifies, about 20 percent are likely to remain viable after adequate screening.

A Pareto chart can be a useful tool for graphically depicting these and other relationships. The chart can help show the user where allocating time, human, and financial resources will yield the best results. Briefly, a Pareto Chart is a bar chart based on cumulative percentages.

Pareto Chart Creation

A Pareto Chart is created as follows: (1) Select the items (problems, issues, actions, publics, etc.) to be compared; (2) Select a standard for measurement; (3) Gather necessary data; (4) Arrange the items on the horizontal axis in a descending order according to the measurements the user selected; and (5) Draw a bar graph where the height is the measurement the user selected.

Pareto Chart Statistics

For the Pareto chart, the following overall statistics are calculated: (1) Mean (the average of all the values in the series, i.e. the average bar height) and (2) Sum (the sum of all the values in the series).

What is Pareto Analysis?

It is a statistical method that aids the user in isolating the major causes of a problem or inputs into a process from the trivial minor causes or inputs. This allows the user to focus the user efforts on causes or inputs that will give the user the greatest results.

When is Pareto Analysis beneficial?

A non-limiting list of benefits of Pareto analysis include: (1) when the user wants to solve a business or personal problem by identifying the most important causes of the problem; (2) when the user wants to identify which products to discontinue in a product line; (3) when the user wants to reduce the business costs; (4) when the user feels that too much information must be analyzed before a decision can be made; (5) when the user wants to make an economical use of the resources; or (6) when the user want to improve the service offered to the customers.

To summarize, numerous people, over the centuries, have observed the existence of the phenomenon of vital few and trivial many as it applied to their local sphere of activity. Pareto observed this phenomenon as applied to distribution of wealth, and advanced the theory of a logarithmic law of income distribution to fit the phenomenon. Lorenz developed a form of cumulative curve to depict the distribution of wealth graphically. Juran was (seemingly) the first to identify the phenomenon of the vital few and trivial many as a “universal,” applicable to many fields. Juran applied the name “The Pareto Principe” to this universal phenomenon. Juran also coined the phrase “vital few and trivial many” and applied the Lorenz curves to depict this universal phenomenon in graphic form.

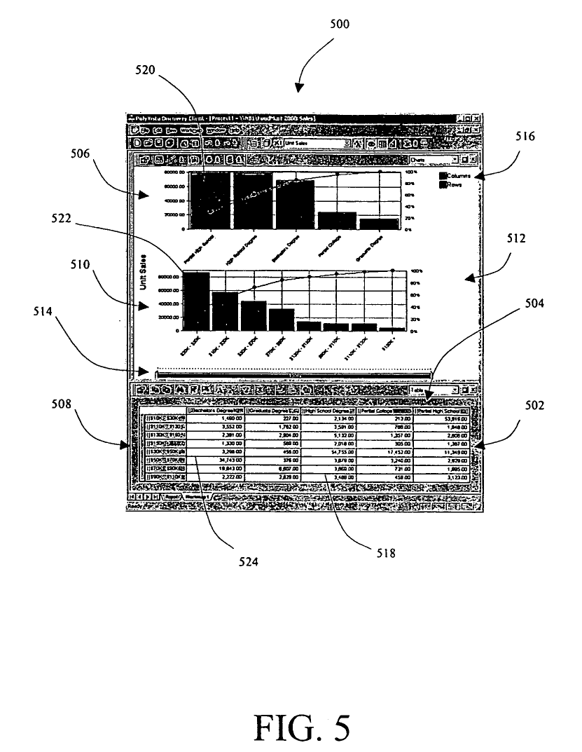

Referring now to FIG. 5, a screen 500 is a representation of the integration of Pareto chart 512 and a cross-tab 502. 504 is the column axis (also known as y-axis) of the cross-tab. 504 is represented by 506 in the Pareto chart. 508 is the row axis (also known as x-axis) of the cross-tab. 508 is represented by 510 in the Pareto chart. 514 is a slider that controls the percent of data shown in the Pareto chart. 516 is a legend to show the row and column information. The column of data 518 is shown by 520 bar in the Pareto chart. The row of data 524 is shown by 522 bar in the Pareto chart.

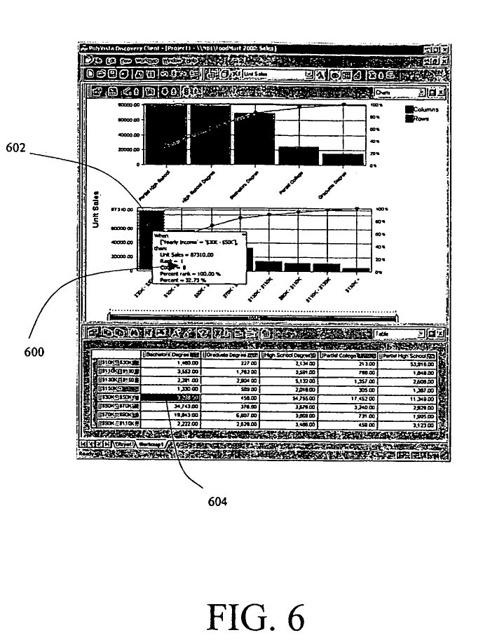

FIG. 6 shows the interaction between the bar 602 of the Pareto chart and the row 604 of the cross-tab when the mouse cursor is over 602. Additional information is shown in the form of a balloon text 600.

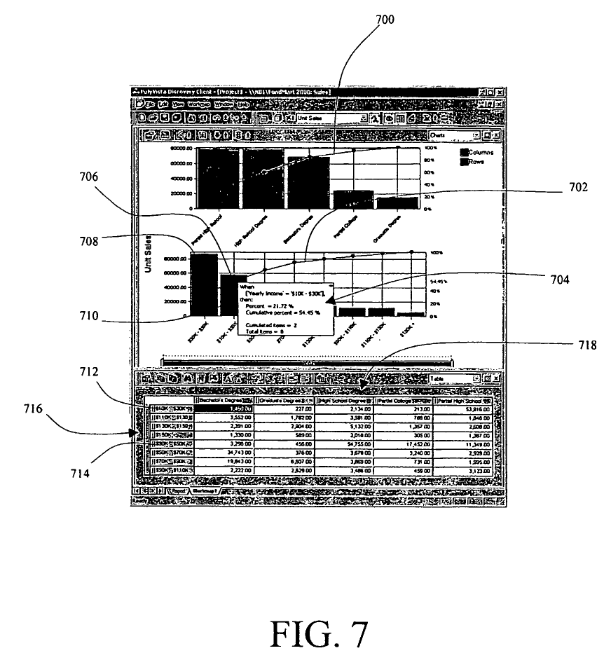

FIG. 7 shows the response of the point 706 of the Pareto chart when mouse cursor is over it. The statistics is displayed in the form of a balloon text 704. The cumulative percent of bar 708 and 710 is shown. Bar 708 is the representation of row 712, and bar 710 is the representation of row 714. Line curve 700 shows the cumulative percent for the column data 718, while line curve 702 shows the cumulative percent for the row data 716.

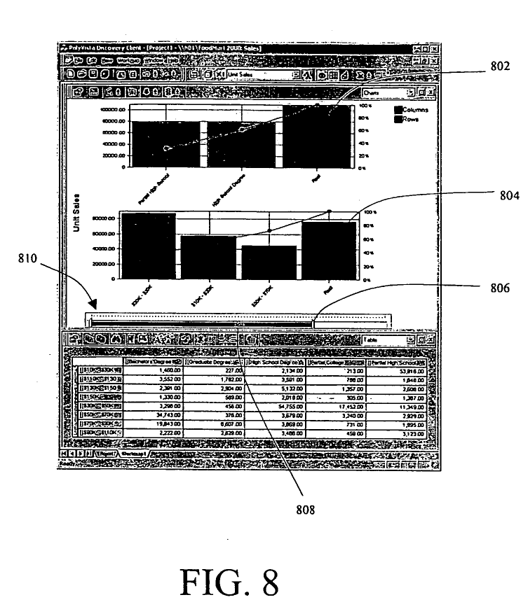

FIG. 8 shows the response of the Pareto charts when slider 810 is manipulated with a pointing device, e.g., a mouse. When the slider thumb 806 is moved with a mouse click-and-drag action, the slider 808 shows the percent of visible data. The row Pareto chart responds by collapsing the scrolled-of data with a bar called “rest” 804. Like the column Pareto chart responds by collapsing the scrolled-of data with a bar called “rest” 802.

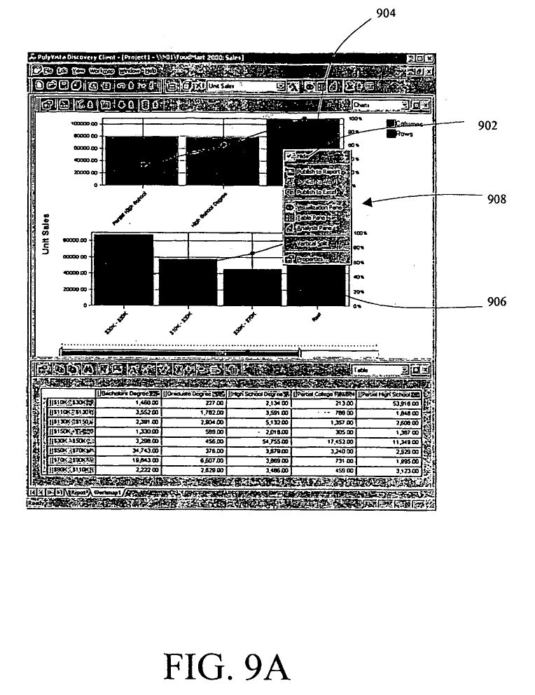

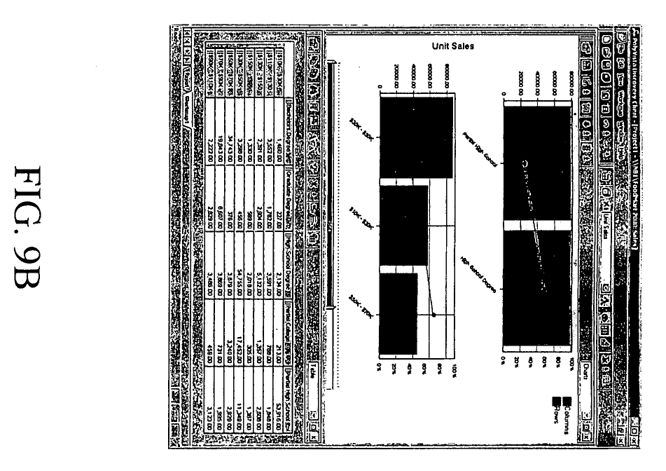

Referring now to FIG. 9A, when a mouse right-click is performed on a “rest” bar 904 or 906, a short-cut menu 908 is displayed. The user can select “hide” 902 with a mouse left-click. As a response to this action the “rest” bars 904 and 906 are hidden, i.e. not displayed. FIG. 9B shows the response to a 902 “hide” operation.

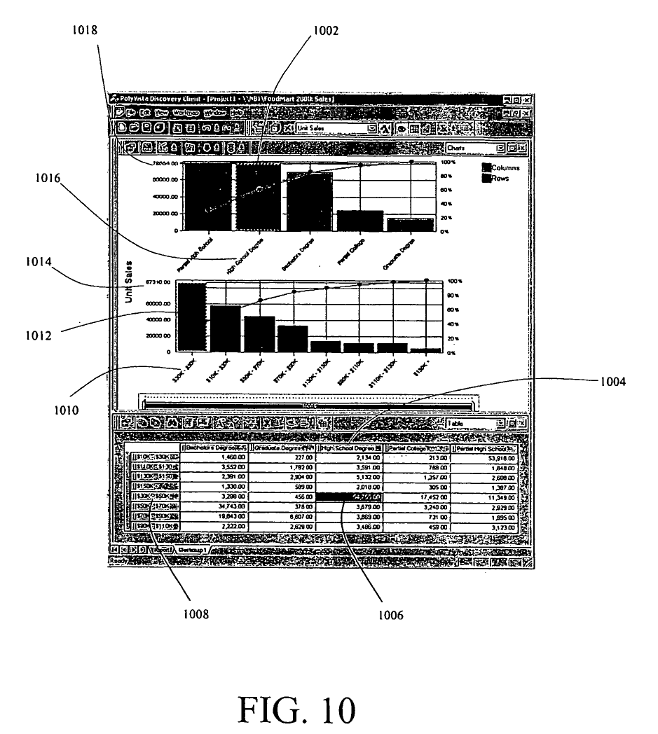

FIG. 10 shows the response to a mouse-over a cell 1006 in the cross-tab. The column Pareto chart responds by highlighting the bar 1002 which corresponds to the column header 1004 in the cross-tab. The column header 1004 is also matched with 1016 highlight. Additionally, the total sum for the column is displayed by 1018. The row Pareto chart responds by highlighting the bar 1012 which corresponds to the row header 1008 in the cross-tab. The row header 1008 is also matched with 1010 highlight. Additionally, the total sum for the row is displayed by 1014.

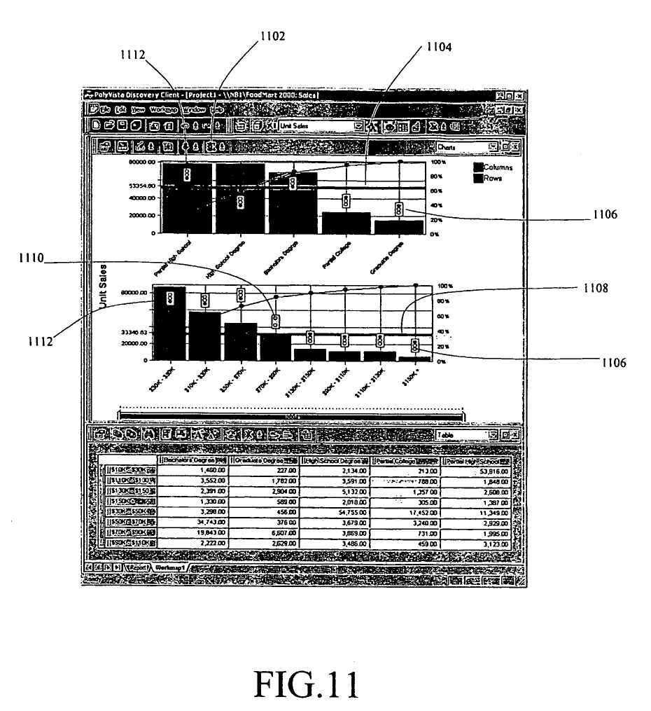

FIG. 11 shows the Traffic Light functionality implemented in Pareto charts. This functionality can be turned on or off from 1102 button. When Traffic Light is turned on, a Target (horizontal) line 1104 and 1108 appear on the charts. The placement of bar is based on a calculation like mean, median, or some user defined function. The Target line can be moved up or down with a mouse. Traffic light symbols 1112, 1110 and 1106 appear on each bar of the Pareto chart. The color shown in each traffic light symbol can either be red, yellow or green depending upon the value of the bar in relationship to the Target line 1104 or 1108. The color of traffic light symbol will change as the Target line 1104 or 1108 is moved up or down.

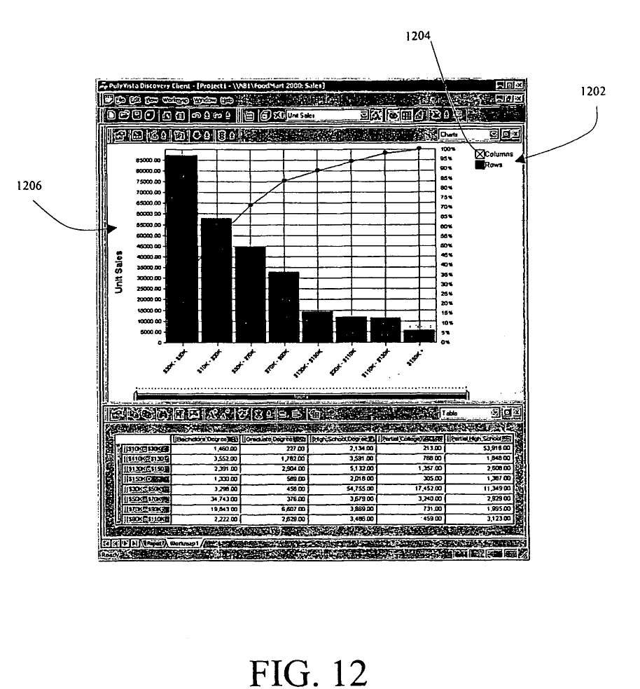

FIG. 12 shows the functionality where one or the other Pareto chart can be hidden. In this case the button 1204 of the legend 1202 has been toggled off. As a result on row Pareto chart 1206 is shown, while column Pareto chart is hidden.

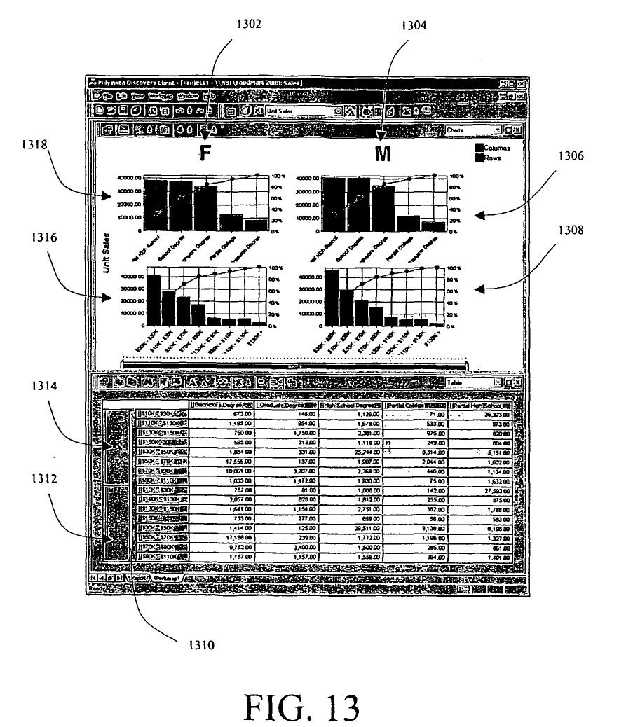

FIG. 13 shows the functionality where three dimensions are shown in Pareto chart. When a dimension 1312 and 1314 is placed to the left of Dimension Separator 1310, the Pareto chart is split 1302 and 1304 to appropriately represent the third dimension. 1302, 1318 and 1316 comprise of one group, while 1304, 1306 and 1308 comprise the other group.

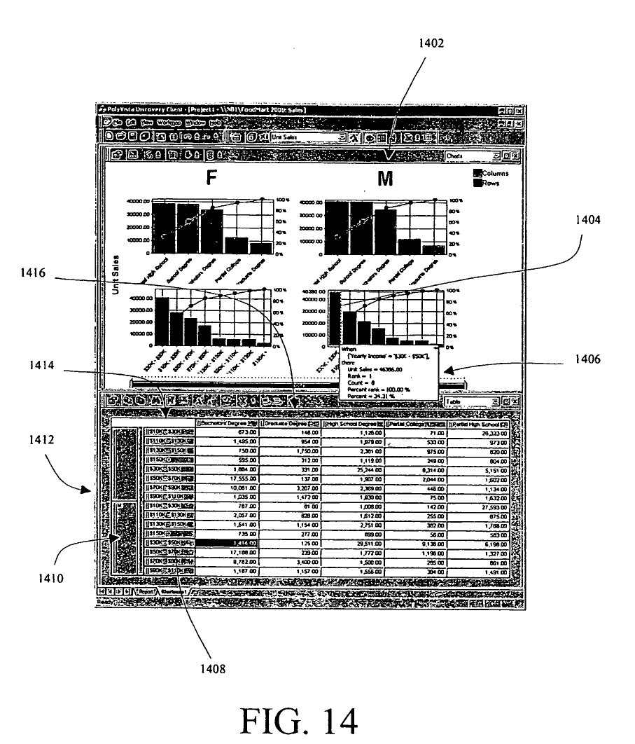

FIG. 14 shows the interaction between Pareto chart and cross-tab when three dimensions 1412, 1414 and 1416 are represented. When a mouse cursor is placed over 1404 in Pareto chart, 1408 is highlighted in cross-tab. Balloon text 1406 is also shown. The 1414 block of cross-tab is represented by 1402 block of Pareto chart.

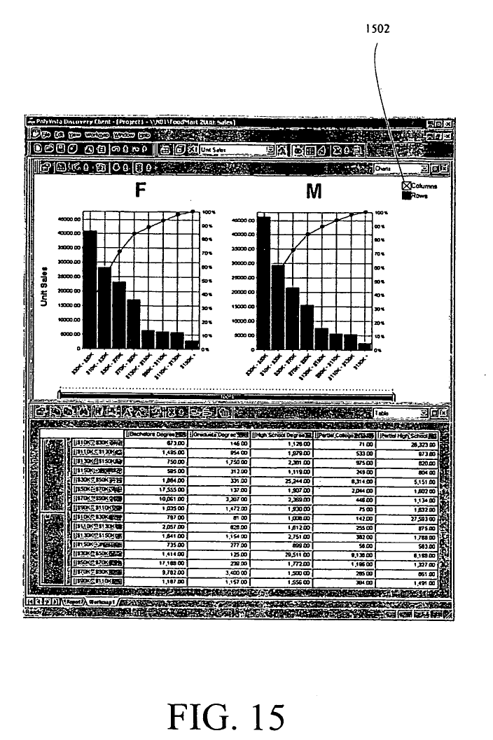

FIG. 15 shows the response when column Pareto chart is turned off by clicking on 1502 column button. In this Pareto chart only row data is shown, while column data is hidden (i.e. not shown).

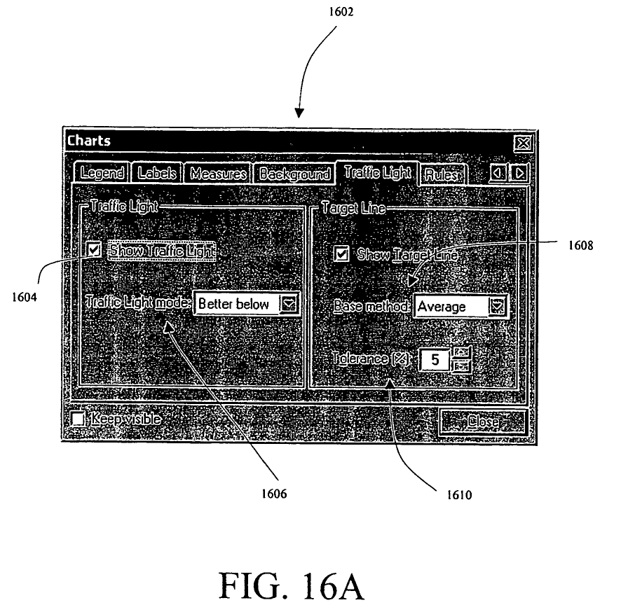

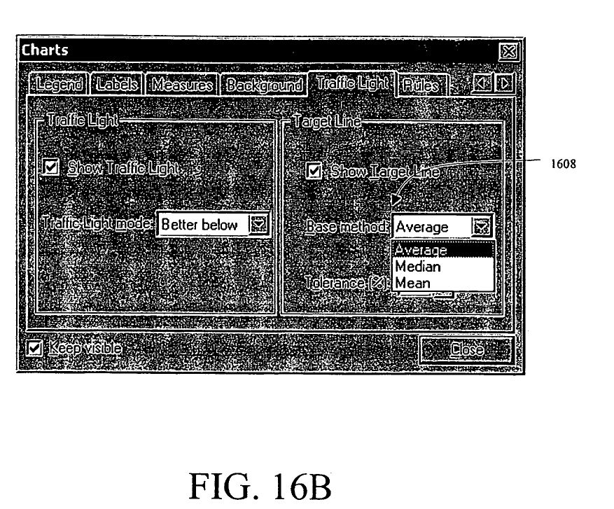

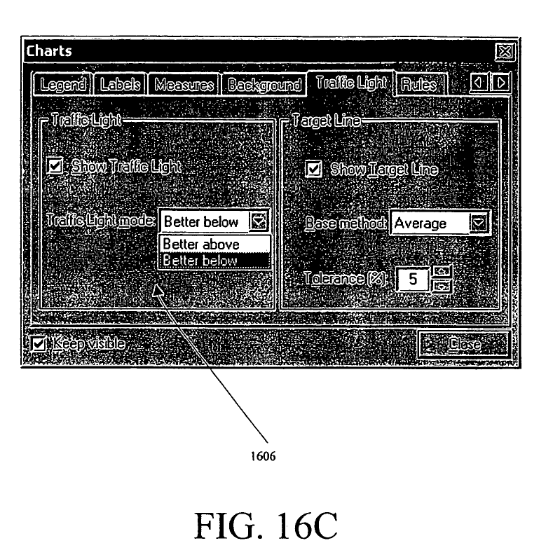

FIG. 16A shows the property dialog 1602 for Traffic Light. Traffic Light can be turned on or off with 1604. The color red or green is context dependent, in some context more (above) is better, while in other context less (below) is better. The appropriate context mode can be set with 1606. The Target line placement can be determined with 1608. The tolerance by which to change color can be controlled with 1610. FIG. 16B shows the Target line placement 1608 options. FIG. 16C shows the Traffic Light mode 1606 options.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

We claim:

1. A method for generating summary reports from multidimensional dataset comprising the steps of:
selecting a search space including data from at least one database;
selecting a search including at least one monotonic constraint;
setting an iteration counter k equal to 1;
generating all k-dimensional item sets;
deleting all k-dimensional item sets that fail the search constraints;
incrementing k by one;
generating all k-dimensional item sets from (k−1) item sets that satisfied the search contraints;
deleting all k-dimensional item sets that fail the search constraints;
testing to determine whether an k-dimension item sets survive; and
repeating the incrementing, generating and deleting steps until no k-dimensional item sets survive or stopping if no k-dimensional items survived the deleting step.

2. The method of claim 1, further comprising the step of: displaying the result in a list.

3. The method of claim 2, further comprising the step of: subjecting at least one result to post creation analysis.

4. The method of claim 3, further comprising the step of: refining the search constraints and repeating the method steps of claim 1.

5. The method of claim 1, wherein the search further includes at least one measure secondary constraint.

6. The method of claim 1, wherein the search further includes at least measure secondary constraint and at least one must-include dimension or dimension level constraint.

7. The method of claim 1, wherein the search further includes at least measure secondary constraint, at least one must-include dimension or dimension level constraint and at least one data filter.

8. A method for generating summary reports from multidimensional dataset comprising the steps of:
selecting a search space including data from at least one database;
selecting a search including at least one monotonic constraint;
setting an iteration counter k equal to 1;
generating all k-dimensional item sets;
deleting all k-dimensional item sets that fail the search constraints;
incrementing k by one;
generating all k-dimensional item sets from (k−1) item sets that satisfied the search contraints;
deleting all k-dimensional item sets that fail the search constraints;
testing to determine whether an k-dimension item sets survive; and
repeating the incrementing, generating and deleting steps until no k-dimensional item sets survive or stopping if no k-dimensional items survived the deleting step;
displaying the result in a list; and
subjecting at least one result to post creation analysis.

9. The method of claim 8, further comprising the step of:
refining the search constraints and repeating the method steps of claim 1.

10. The method of claim 8, wherein the search further includes at least one measure secondary constraint.

11. The method of claim 8, wherein the search further includes at least measure secondary constraint and at least one must-include dimension or dimension level constraint.

12. The method of claim 8, wherein the search further includes at least measure secondary constraint, at least one must-include dimension or dimension level constraint and at least one data filter.

13. A method for generating summary reports from multidimensional dataset comprising the steps of:
selecting a search space including data from at least one database;
selecting a search including at least one monotonic constraint;
setting an iteration counter k equal to 1;
generating all k-dimensional item sets;
deleting all k-dimensional item sets that fail the search constraints;
incrementing k by one;
generating all k-dimensional item sets from (k−1) item sets that satisfied the search contraints;
deleting all k-dimensional item sets that fail the search constraints;
testing to determine whether an k-dimension item sets survive; and
repeating the incrementing, generating and deleting steps until no k-dimensional item sets survive or stopping if no k-dimensional items survived the deleting step;
displaying the result in a list;
subjecting at least one result to post creation analysis; and
refining the search constraints and repeating the method steps of claim 1.

14. The method of claim 13, further comprising the step of:
storing the original search and refined search in a database file.

15. The method of claim 14, further comprising the step of:
forming a heuristic from the stored original search and refined search in a database file to aid in search construction for specific search spaces.

16. The method of claim 13, wherein the search further includes at least one measure secondary constraint.

17. The method of claim 13, wherein the search further includes at least measure secondary constraint and at least one must-include dimension or dimension level constraint.

18. The method of claim 13, wherein the search further includes at least measure secondary constraint, at least one must-include dimension or dimension level constraint and at least one data filter.

18. A method for displaying and visually analyzing data in n-dimensional cross-tabs comprising the steps of:
selecting a cross-tab cell; and
generating a Pareto chart for each dimension of the selected cell.

19. A computer or computer readable memory comprising an computer executable instruction set encoding the methods of claims 1-18.
